(19) United States
(12) Patent Application Publication
(10) Pub. No.: US 2018/0292104 A1
(43) Pub. Date: Oct. 11, 2018

(54) FLOORING GRATE WITH CHANNEL GRATE AND CROSS BARS AND METHOD FOR MANUFACTURING SAME

(71) Applicant: AIRFIXTURE LLC, KANSAS CITY, KS (US)

(72) Inventors: MICHAEL J. McQUEENY, JR., LEAWOOD, KS (US); PEDRO J. BERMUDEZ, OLATHE, KS (US)

(21) Appl. No.: 15/482,568

(22) Filed: Apr. 7, 2017

(51) Int. Cl. F24F 13/08

(52) U.S. Cl. CPC F24F 13/082; A01K 1/0151; F24F 13/08; F24F 13/084

(57) ABSTRACT

A grate constructed in accordance with the present invention is used in connection with HVAC applications and systems and may be placed in an opening of an air duct in a floor. The grate has a plurality of grate bars and cross bars that are formed from strips of prefinished metal cut from a sheet of metal that are bent around a form to provide an upside down “U” shaped cross-section defining a channel. Pairs of grooves are formed across a top of each cross bar and portions of the grate bar. The grate bars are positioned above the cross bars in a perpendicular manner and portions of the grate bars are received in the pairs of grooves. The grate bars and the cross bars are coupled together by moving the portions of the grate bars received in the grooves away from each other, thereby wedging them together.

### CROSS-REFERENCE TO RELATED APPLICATIONS

Not applicable.

### STATEMENT REGARDING FEDERALLY SPONSORED RESEARCH OR DEVELOPMENT

Not applicable.

### BRIEF SUMMARY OF THE INVENTION

The present invention is directed towards a flooring grate of novel construction, which may be used in connection with heating, ventilation, and air conditioning systems (HVAC systems). Throughout this application, the invention is referred to as a “channel grate,” and the use of this terminology shall encompass any synonyms used in the art such as floor register, diffuser, grille, etc. The channel grate may be configured for placement at an opening of an air duct positioned in a floor. Further, the channel grate includes a plurality of grate bars and a plurality of perpendicularly oriented cross bars that are coupled to one another at points of intersection. The plurality of grate bars may be laid over top the plurality of cross bars allowing the pluralities of bars to extend in a manner that presents a grid-like structure. As such, the channel grate is configured to provide substantial weight support and to allow air to pass therethrough.

The prior art discusses floor registers, diffusers, grates, and the like, which include multiple component parts made of solid metal that are welded together. The component parts are polished or finished to improve the aesthetic appearance of the devices. In some instances, the devices are finished by applying an aesthetically pleasing cover, such as aluminum or stainless steel. In any case, the costs associated with constructing these prior art devices are often high due to the use of solid component parts and the labor requirements of welding and finishing.

The present invention provides an improvement over the prior art devices as the channel grate may be constructed from less material with minimal labor. The channel grate uses fabricated sheet like materials to form the pluralities of grate bars and cross bars, which are constructed by forming or folding strips of the sheet like material over a mold into hollow-like rectangles with one side removed (i.e., “channels”). Thus, cross-sections of the pluralities of grate bars and cross bars may resemble an upside down “U” shape. In addition, the pluralities of grate bars and cross bars are comprised of at least two individual bars. The individual grate bars share an identical structure and extend in a uniform manner above the individual cross bars. Similarly, the individual cross bars also share an identical structure and extend in a uniform manner below the individual grate bars.

Furthermore, the pluralities of bars are perpendicularly positioned, which causes the individual grate bars to overlap with the individual cross bars at intersecting regions. The channel grate may be configured such that the plurality of grate and cross bars are joined at the intersecting regions by a plurality of connections in a manner that causes the plurality of bars to be coupled together to form a grid-like structure. In exemplary embodiments, the plurality of connections includes multiple pairs of grooves along a top side of each cross bar that are complementary to portions of the grate bar. Further, a portion of the grate bar proximate to the cross bar in the intersecting region extends vertically downwardly into one of the multiple pairs of grooves. The grate bars are then widened in the intersecting regions, thereby causing portions of the grate bars to be wedged into a mating connection with the multiple pairs of grooves of the cross bars.

Accordingly, the hollow, channel-like structure of the grate bars and the cross bars significantly reduces the amount of material needed to construct the channel grate. In addition, the plurality of connections at the intersecting regions, as well as the use of fabricated sheet like material, reduces the amount of labor needed, as less finishing is required and welding is not necessary. Moreover, the channel grate's ability to support substantial weight and to have an aesthetically pleasing appearance are not compromised despite using less material, performing less, if any, finishing, and not requiring welding or mechanical fasteners. The present invention provides an improved channel grate that can be produced more quickly and with less material than prior art devices.

Further objects, features and advantages of the present invention over the prior art will become apparent from the detailed description of the drawings which follows, when considered with the attached figures.

### BRIEF DESCRIPTION OF THE SEVERAL VIEWS OF THE DRAWINGS

The features of the invention noted above are explained in more detail with reference to the embodiments illustrated in the attached figures, in which like reference numerals denote like elements, in which FIGS. 3-9 illustrate possible embodiments of the present invention, and in which:

FIG. 1 is a fragmentary, perspective view of an embodiment of a prior art grate constructed with solid grate bars and cross bars;

FIG. 2 is a fragmentary, perspective view of an embodiment of a prior art grate constructed with solid grate bars and cross bars clad in a sheet material;

FIG. 3 is a top, front perspective view of a channel grate, in accordance with an embodiment of the present invention;

FIG. 4 is an enlarged, fragmentary, side elevation view of the channel grate of FIG. 3;

FIG. 5 is a fragmentary, top, font perspective view of the channel grate of FIG. 3 with one of the channel grate bars exploded and one of the channel grate bars missing for clarity;

FIG. 6 is a top, front perspective view of a cross bar of the channel grate of FIG. 3;

FIG. 7 is a fragmentary, bottom plan view of the channel grate of FIG. 3;

FIG. 8 is an enlarged, fragmentary, bottom plan view of a portion of the channel grate of FIG. 7 taken in the area 8, in accordance with an embodiment of the present invention; and

FIG. 9 illustrates the portion of the channel grate of FIG. 8, but with the channels of the grate bars filled with a foam material, in accordance with an alternate embodiment of the present invention.

### DETAILED DESCRIPTION OF THE INVENTION

Referring now to the drawings in more detail, numeral 10 generally designates a channel grate constructed in accordance with an embodiment of the present invention. The channel grate 10 includes a plurality of grate bars 20 and a plurality cross bars 60, which are configured and arranged such that the channel grate 10 may support substantial weight, be aesthetically pleasing, and allow for air passage therethrough.

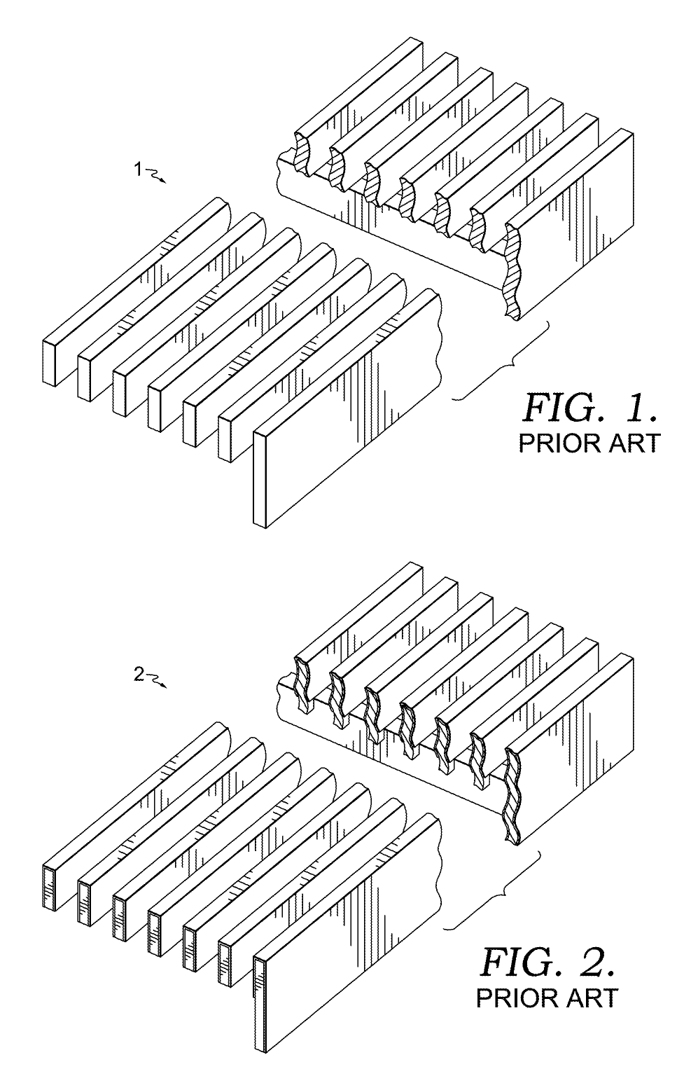

Starting with FIGS. 1 and 2, prior art versions of grates are shown. As can be seen in FIG. 1, this prior art version of a grate 1 uses solid bar stock as component parts. The grate bars and cross bars not only use a lot of material, but they must be welded together to form the grate. Similarly, FIG. 2 illustrates a prior art grate 2 where the grate bars and cross bars are formed of bar stock, but where the grate bars are clad in strips of material in order to provide a more aesthetically pleasing appearance. This embodiment has cost savings over the embodiment of FIG. 1, in that the solid bar stock may be of a less expensive material (e.g., steel) than the cladding material (e.g., stainless steel) and the cladding material may be prefinished, thereby reducing finishing costs. However, the construction of both devices requires a significant amount of material and welding of component parts. As such, the prior art grates use substantially more material than the present invention and require more labor due to welding and finishing.

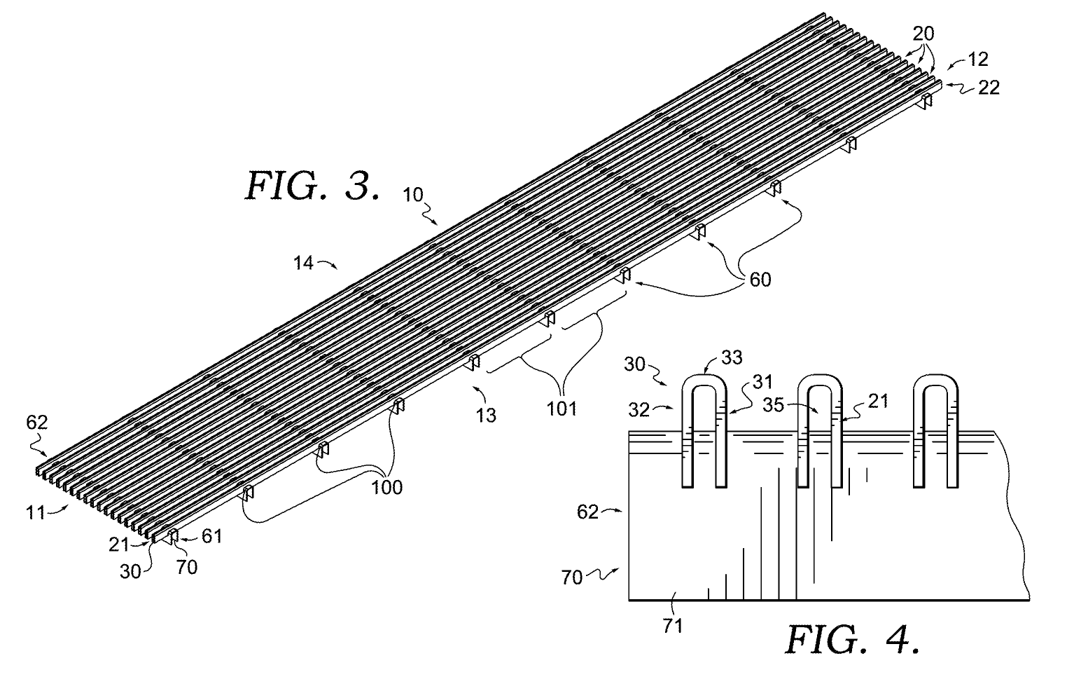

Referring now to FIG. 3, an exemplary embodiment of a channel grate 10 in accordance with the present invention is depicted. As shown, the channel grate 10 includes a plurality of grate bars 20 and a plurality of cross bars 60. The plurality of grate bars 20 extend in a longitudinal direction along the length of the channel grate 10 while the plurality of cross bars 60 extend in a lateral direction across the channel grate 10. Further, the plurality of grate bars 20 superpose and extend over the top of the plurality of cross bars 60 and, therefore, the pluralities of grate and cross bars 20, 60 overlap and intersect at multiple intersecting regions 100. As the pluralities of grate and cross bars 20, 60 may be positioned perpendicularly to each other, substantially right angles may be formed at the multiple intersecting regions 100. In addition, both the plurality of grate bars 20 and the plurality of cross bars 60 may include at least two individual bars, which are referred to as a grate bar 30 and a cross bar 70, respectively. Each grate bar 30 included in the plurality of grate bars 20 may share a similar structure, extend in a similar direction, and be evenly spaced from adjacent grate bars 30. Likewise, the same is true for each cross bar 70 included in the plurality of cross bars 60. Moreover, the grate bar 30 and the cross bar 70 may be positioned perpendicular to each other with the grate bar 30 atop the cross bar 70. Thus, each grate bar 30 may intersect with each cross bar 70 at the multiple intersecting regions 100 to form a uniform structure of the channel grate 10 in which each grate bar 30 is separated from other, adjacent grate bars 30 by an equal distance, and each grate bar 30 intersects with the plurality of cross bars 60 at a same position, relative to each cross bar 70. Similarly, each cross bar 70 is configured and positioned in the same uniform manner and, therefore, intersects with the plurality of grate bars 20 at a same position, relative to each grate bar 30.

In some aspects, the pluralities of grate and cross bars 20, 60 may employ any number and configuration of the respective grate or cross bar 30, 70 in order to meet dimensional and structural needs of the channel grate 10. Moreover, edges of the grate bar 30 and the cross bar 70 may collectively define ends of the channel grate 10 such that the plurality of grate bars 20 extend between a first end 11 and a second end 12 and the plurality of cross bars 60 extend between a front end 13 and a rear end 14. In further aspects, the pluralities of grate and cross bars 20, 60 may respectively include a varying number of the grate bar 30 and the cross bar 70. For example, FIG. 3 depicts a channel grate 10 in which the plurality of grate bars 20 includes eighteen grate bars 30, and the plurality of cross bars 60 includes eleven cross bars 70. In even further aspects, each grate bar 30 may be spaced apart from each adjacent grate bar 30 between the front end 13 and the rear end 14 by a uniform distance that may be varied depending on aesthetic and/or structural desires. Similarly, each cross bar 70 may be spaced apart from each adjacent cross bar 70 between the first end 11 and the second end 12 by a distance that may be varied depending on weight bearing needs, aesthetics, and the like.

The channel grate 10 and any component parts, which include the pluralities of grate and cross bars 20, 60, may be constructed from a metal material, including but not limited to, stainless steel, mild steel, aluminized steel, painted steel, galvanized steel, aluminum, copper, copper alloys such as cupronickel, Muntz metal, or similar materials that have comparable strength properties and/or desirable aesthetic properties. In certain aspects, the channel grate 10 and any component parts may be constructed from a combination of materials, which may include two or more of the foregoing metal materials or similar materials that have comparable properties. Additionally, the channel grate 10 and any of the component parts may be molded, cast, formed, machined or constructed into a desired shape. In one embodiment of the present invention, to construct each grate bar 30, a strip of a desired size and shape may be cut from a sheet of metal and then the strip may be formed into a desired “U” shape by bending the strip around a mold or frame. In some embodiments, the channel grate 10 and any component parts may be fabricated from prefinished sheet stainless material, such as steel, or other suitable prefinished sheet material like mild steel, aluminized steel, painted steel, galvanized steel, aluminum, copper, copper alloys such as cupronickel, Muntz metal, or combinations thereof. During use, a channel grate 10 that was constructed in accordance with the present invention from such sheet materials demonstrated similar structural strength as prior art grates whose construction used 82% more metal by weight. Furthermore, constructing the channel grate 10 from prefinished sheet material required 95% less finishing and polishing than prior art grates constructed from conventional materials known in the art.

Referring now to FIG. 4 and with continued reference to FIG. 3, a magnified portion of the channel grate 10 from FIG. 3 is shown. As mentioned, the plurality of grate bars 20 extend longitudinally, and thus, the grate bar 30 also extends longitudinally in a uniform manner such that each grate bar 30 is substantially parallel to one another. Comparably, the cross bar 70 extends laterally in a uniform manner in which each cross bar 70 is substantially parallel to one another. Accordingly, the grate bar 30 and the cross bar 70 are positioned perpendicularly and intersect to form the multiple intersecting regions 100 as they extend in their respective directions. When not intersecting, the grate bar 30 extends between the cross 70 bar along multiple non-intersecting regions 101.

In more detail, the grate bar 30 may include a first grate end 21, a second grate end 22 and further include a first side 31, a second side 32, and third side 33, all of which extend between the first and second grate ends 21, 22. As depicted in FIG. 4, the grate bar 30 may present a downward facing or upside down “U” at the first and second grate ends 21, 22 with the first and second sides 31, 32 forming longer, mirrored vertical portions and the third side 33 forming a horizontal portion extending between the first and second sides 31, 32. Further, the first side 31 and the second side 32 connect with opposite sides of the third side 33 and therefore, are positioned in a generally parallel manner. Moreover, an edge is presented where the first and second sides 31, 32 connect with the third side 33, which may be rounded or chamfered. The “U” shape may be maintained throughout the grate bar 30, and thus, the first, second, and third sides 31, 32, 33 may be substantially planar. Moreover, a cross-section of the grate bar 30 may have the “U” shape. As such, a grate channel 35 may be defined by the first, second, and third sides 31, 32, 33 that extends along an interior surface 40 of the grate bar 30. Further, the grate channel 35 may have a first width 36 that may be similar to a distance of the third side 33 measured between the opposite edges which join with the first and second sides 31, 32. The first width 36 may also be similar to a distance between the interior surface 40 of the first and second sides 31, 32 in a lateral direction or a direction between the front end 13 and the rear end 14.

With reference to FIGS. 4-6, the cross bar 70 has a similar structure to the grate bar 30. The cross bar 70 may include a front cross end 61, a rear cross end 62, and a front side 71, a rear side 72, and a top side 73, which extend between the front and rear cross ends 61, 62. Further, the cross bar 70 may also be “U” shaped with the front and rear sides 71, 72 forming vertical portions, and the top side 73 forming a horizontal portion that joins with the front and rear sides 71, 72. Thus, a cross-section shape of the cross bar 70 may be a “U” shape. Moreover, the front side 71 and the rear side 72 connect with opposite sides of the top side 73 and thus, are generally parallel. The top side 73 may form a substantially right angle with the front and rear sides 71, 72 along respective edges, which may be rounded or chamfered. As the cross bar 70 extends laterally, the front and rear sides 71, 72 are vertically planar while the top side 73 is horizontally planar. Additionally, a cross channel 75 may be formed by the front, rear, and top sides 71, 72, 73 that extends along an inner surface 80 of the cross bar 70.

In further aspects, specific dimensions and aspects of the grate bar 30 and the cross bar 70 may vary depending on several factors such as end-use of the channel grate 10. As such, dimensions and aspects of the grate bar 30 and the cross bar 70 may be tailored and customized to meet a customer's specific needs. Furthermore, each grate bar 30 may have a similar structure sharing the same length, height, thickness, etc., and the plurality of grate bars 20 maintain a uniform configuration as each grate bar 30 extends in the same direction, is parallel to each other, and is evenly spaced apart. Likewise, each cross bar 70 may also share structural similarities. Accordingly, each cross bar 70 may be the same length, height, thickness, etc. and employ a uniform configuration by extending in the same direction, being parallel, and being evenly spaced apart. In an exemplary embodiment, the grate bar 30 may be extend a distance between the first grate end 21 and the second grate end 22 and may extend a distance between the first side 31 and the second side 32. The cross bar 70 may extend a distance between the front cross end 61 and the rear cross end 62 and extend a distance between the front side 71 and the rear side 32. Notwithstanding, the channel grate 10 may include any number of grate bars 30 and cross bars 70 with varying dimensions. In an alternate embodiment, the sizes of adjacent grate bars 30 may vary to provide pleasing aesthetics and/or varying weight loads. Along those lines, the load bearing capabilities of the grate and cross bars 30, 70 may be modified by varying the thickness of the metal used, the spacing between the sides 31, 32, and/or the height of the sides 31, 32.

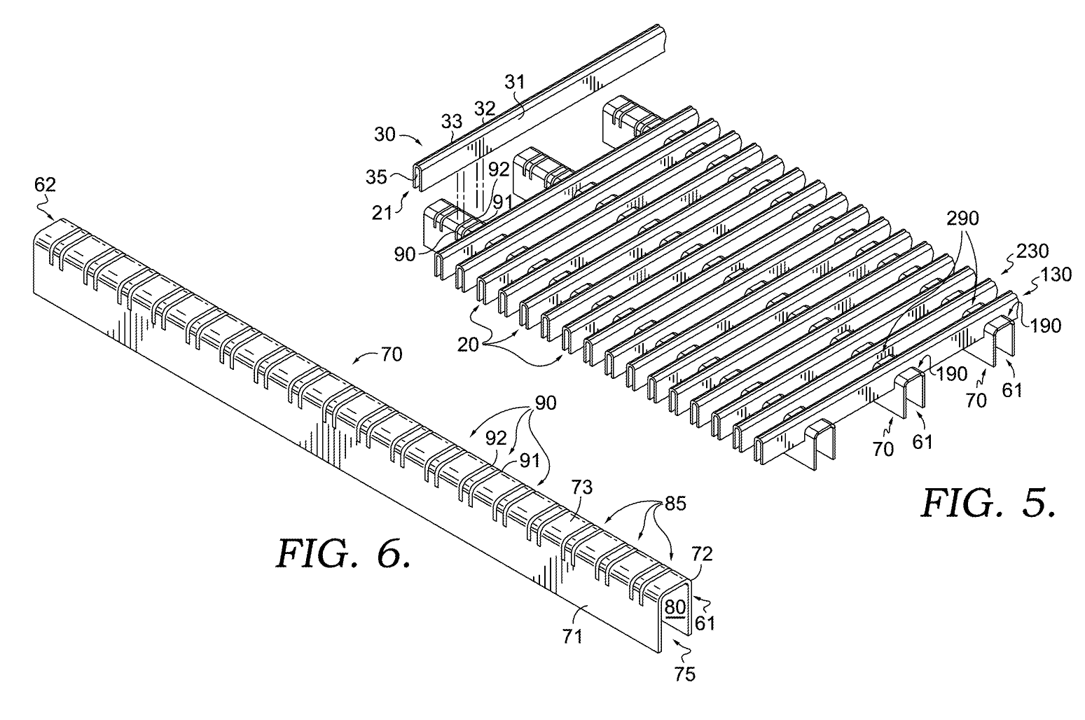

Turning now to FIGS. 5 and 6, FIG. 5 shows integration of the plurality of grate bars 20 and the plurality of cross bars 60 of the channel grate 10 of FIG. 3, and FIG. 6 shows the cross bar 70 apart from the channel grate 10. As depicted, each grate bar 30 and each cross bar 70 are positioned such that their respective “U” shapes are downward, and thus, the first and second sides 31, 32 of each grate bar 30 are proximate to the top side 73 of each cross bar 70. Furthermore, the cross bar 70 includes a plurality of connection locations 85 where the cross bar 70 will join with the grate bar 30. The plurality of connection locations 85 are areas where any manner of connecting a cross bar 70 with a grate bar 30 may be used, such as a screw, rivet, adhesive, weld, wedge, etc. In the illustrated embodiments of the present invention the manner of connecting a cross bar 70 with a grate bar 30 at a connection location 85 includes multiple pairs of grooves 90, which laterally traverse the top side 73, extend in the same direction as each grate bar 30, and are evenly spaced apart. Moreover, each pair of the multiple pairs of grooves 90 has a first groove 91 and a second groove 92 that are uniformly separated in a longitudinal direction.

In further aspects, each pair of the multiple pairs of grooves 90 corresponds to a connection point for one grate bar 30 of the plurality of grate bars 20 to the cross bar 70 such that a portion of the first side 31 of the grate bar 30 proximate a distal edge is received in the first groove 91 and a portion of the second side 32 of the grate bar 30 proximate a distal edge is received in the second groove 92. To this same degree, the first and second grooves 91, 92 extend throughout a portion of the cross bar 70 in the same vertical direction as the first and second sides 31, 32 extend in the grate bar 30. The first and second grooves 91, 92 may be separated by a distance that is equal to the distance of the first width 36 of the grate channel 35, which separates the first and second sides 31, 32. As such, the first and second grooves 91, 92 and the first and second sides 31, 32 are configured to have complementary sizes and orientations to allow for the coupling of the grate bars 30 and cross bars 70.

In even further aspects, such coupling of the grate bars 30 and cross bars 70 may increase a load bearing capacity of both the grate bars 30 and cross bars 70 and in turn, may increase a load bearing capacity of the channel grate 10. For instance, the first and second sides 31, 32 of the grate bars 30 may be respectively received by the first and second grooves 91, 92 of the cross bars 70, and therefore, the grate bars 30 may be firmly fixed or secured to the cross bars 70 at two points. Moreover, the first side 31 and the second side 32 may be positioned within the first and second grooves 91, 92 such that a distal portion of each side 31, 32 may be independently secured along a portion of the interior surface 40 and along a portion of an opposing outside surface (e.g., the first side 31 is sandwiched within the first groove 91 along two opposing sides, and the second side 32 is sandwiched within the second groove 92 along two opposing sides). Accordingly, the first and second sides 31, 32 may each provide a vertical column of support for the grate bars 30 that may be coupled to the first and second grooves, 91, 92 at a distal portion along mutually opposing sides. Such coupling may reduce lateral disbursement of a downward force received by the channel grate 10 from weight bearing, and the first and second sides 31, 32 may have a greater critical load than similar components used in prior art grates. Stated another way, the grate bars 30 and cross bars 70 may withstand heavy weight bearing conditions prior to buckling at the first and second sides 31, 32, and the channel grate 10 may be capable of supporting a same or greater amount of weight as prior art devices while using less material.

In other aspects, the multiple pairs of grooves 90 may be evenly spaced throughout the cross bar 70, and the multiple pairs of grooves 90 of each cross bar 70 included in the plurality of cross bars 60 may have this same even spacing. Additionally, each pair of the multiple pairs of grooves 90 may be separated by a same distance as each grate bar 30 in the plurality of grate bars 20. Moreover, the multiple pairs of grooves 90 of the cross bar 70 may be placed at a same location and at a same position on each cross bar 70 of the plurality of cross bars 60. For example, a first pair of the multiple pairs of grooves 190 may be positioned on each of the cross bars 60 at an equal distance from the front cross end 61, while a second pair of the multiple pairs of grooves 290 may be positioned on each of the cross bars 60 at an equal distance from the front cross end 61 that is greater than the distance of the first pair of the multiple pairs of grooves 90. Accordingly, the first pair of the multiple pairs of grooves 190 may couple with a first grate bar 130, and the second pair of the multiple pairs of grooves 290 may couple with a second same grate bar 230.

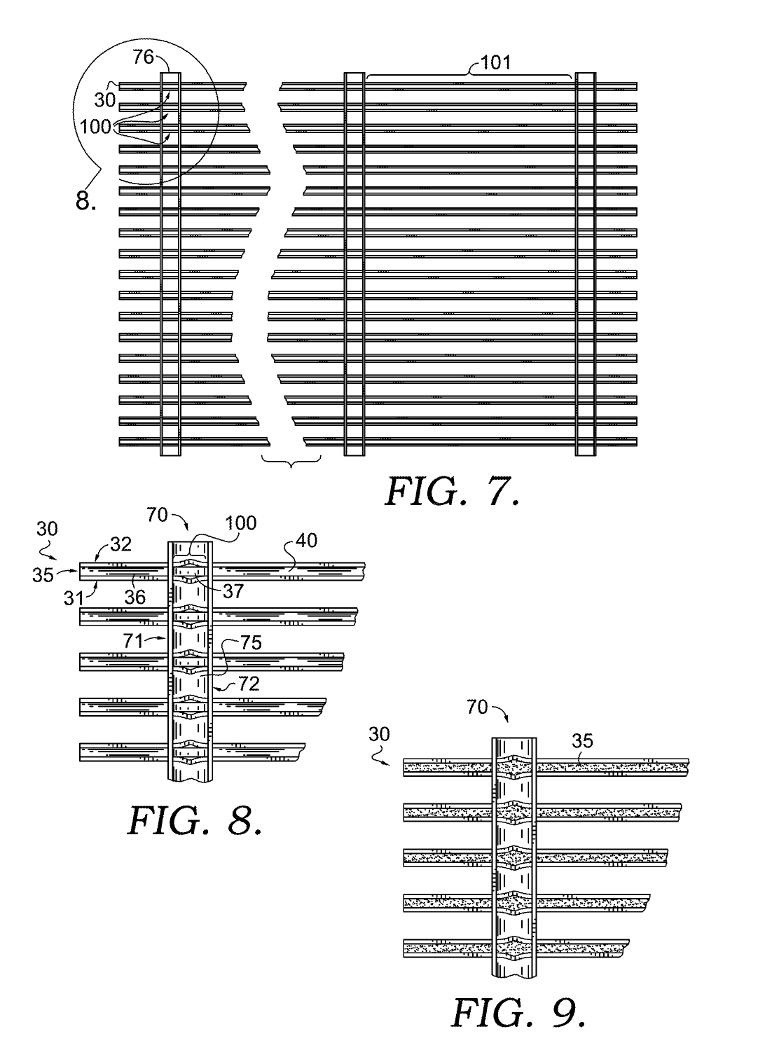

With reference now to FIGS. 7 and 8 and continued reference to FIGS. 5 and 6, the channel grate 10 is shown with the plurality of grate bars 20 coupled with the plurality of cross bars 60. Coupling of the bars 20, 60 occurs along the multiple intersecting regions 100 where the first and second sides 31, 32 of each grate bar 30 are placed within and are contiguous with one pair of the multiple pairs of grooves 90 of each cross bar 70. The multiple intersecting regions 100 may be formed wherever the plurality of grate bars 20 overlap with the plurality of cross bars 60, and thus, the multiple intersecting regions 100 are structurally similar and positioned throughout the channel grate 10. More pointedly, at the multiple intersecting regions 100, the first and second sides 31, 32 extend into the multiple pairs of grooves 90, which may extend laterally across the top side 73 and vertically downward along a portion of the front and rear sides 71, 72 of the cross bar 70. Moreover, the multiple pairs of grooves 90 may be configured such that the first and second grooves 91, 92 securely receive the first and second sides 31, 32, respectively. In doing so, the first and second grooves 91, 92 may be sized and shaped in a manner that is complimentary to the size and shape (i.e., thickness) of the first and second sides 31, 32.

In further aspects, the channel grate 10 may be configured such that the pluralities of grate and cross bars 20, 60 couple at the multiple intersecting regions 100 in a manner that permanently fixes the configuration of the channel grate 10. FIG. 8 shows the bottom of the channel grate 10 in more detail and depicts one possible manner of coupling the bars 20, 60 together. In the illustrated embodiment of the present invention, the relationship between the first and second sides 31, 32 of the grate bar 30 are altered at the multiple intersecting regions 100 by applying a force to the first and second sides 31, 32 of the grate bar 30 sufficient to bend the first and second sides 31, 32 and further separate the interior surface 40 of the first and second sides 31, 32. Thus, along the multiple intersecting regions 100, the grate channel 35 is widened to a second width 37 that that is greater than the first width 36. The second width 37 may be a variable distance that is not less than the first width 36 and therefore, is a greater distance than a distance between the first and second grooves 91, 92. Increasing separation between the first and second sides 31, 32 along the multiples intersecting regions 100 to the second width 37 wedges the grate bar 30 into the multiple pairs of grooves 90 of the cross bar 70 and prevents removal of the first and second sides 31, 32 from receipt in the first and second grooves 91, 92. Said differently, at the multiple intersecting regions 100 the interior surface 40 of the first and second sides 31, 32 are separated by a distance of the second width 37 while being uniformly separated by a distance of the first width 36 along the multiple non-intersection regions 101. In use, a greater distance of separation at the multiple intersecting regions 100 than at the multiple non-intersecting regions 101 prevents horizontal and vertical movement of the plurality of grate bars 20 with respect to the plurality of cross bars 60 because the first and second sides 31, 32 and the first and second grooves 91, 92 are no longer oriented in a complementary manner, or the first and second sides 31, 32 are separated at the interior surface 40 by a greater distance than the first and second grooves 91, 92, both in a same longitudinal direction.

It should be noted that while the distance between the interior surface 40 of the first side 31 and the interior surface 40 of the second side 32 of the grate bar 30 is greater in the intersecting regions 100 than in the non-intersecting regions 101 in the illustrated embodiment, it is well within the scope of the present invention to create a secure connection between a grate bar 30 and a cross bar 70 by narrowing the distance between the interior surface 40 of the first side 31 and the interior surface 40 of the second side 32 in the intersecting regions 100 when compared to the distance between the sides 31, 32 in the non-intersecting regions 101 (i.e., pinching the sides 31, 32 together instead of spreading them apart).

In FIG. 9, an alternate embodiment of the channel grate 10 of FIG. 8 is shown.

Here, the metal members of the channel grate 10 (i.e., the grate and cross bars 30, 70) are the same as described in connection with the embodiment in FIG. 8, but a sound deadening material has been added to fill the grate channel 35 of each grate bar 30 of the plurality of grate bars 20. Although not shown, the same or a similar material may also be included in a likewise manner in the cross channel 75 of each cross bar 70 the plurality of cross bars 60. The sound deadening material may receive or deflect sound waves and help reduce an overall noise level of an area which uses the channel grate 10 over various ducts. In further aspects, the sound deadening material may have additional properties, which improve the structural integrity of the channel grate 10. For instance, the sound deadening material may include adhesive properties to allow for improved coupling between the plurality of grate bars 20 and the plurality of cross bars 60 and may assist with preventing movement there between. Further, filling the grate or cross channels 35, 75 of the pluralities of grate and cross bars 20, 60 with such a material may provide additional structural support which aids the channel grate 10 in maintaining a uniform shape during weight bearing or other high-stress conditions.

A method for manufacturing the channel grate 10 may comprise the following steps. Beginning with a first step, individual strips of metal are cut from a prefinished sheet of metal. Next, some of the individual strips are bent over a mold or frame and are formed into the structure of the grate bars 30. Additionally, some of the individual strips are bent over a mold or frame and are formed into the structure of the cross bars 70. Multiple pairs of grooves 90 are then cut into each cross bar 70 such that portions of the grate bars 30 may be inserted therein. The grate bars 30 are placed atop the cross bars 70 and inserted into the multiple pairs of grooves 90. The grate bars 30 and cross 70 bars are then coupled together by bending portions of the grate bars 30 received inside the multiple pairs of grooves 90.

From the foregoing it will be seen that this invention is one well adapted to attain all ends and objects hereinabove set forth together with the other advantages which are obvious and which are inherent to the device and method. It will be understood that certain features and subcombinations are of utility and may be employed without reference to other features and subcombinations. This is contemplated by and is within the scope of the invention.

Since many possible embodiments may be made of the invention without departing from the scope thereof, it is to be understood that all matter herein set forth or shown in the accompanying drawings is to be interpreted as illustrative of applications of the principles of this invention, and not in a limiting sense.

What is claimed is:

1. A grate comprising:
a plurality of grate bars, each grate bar having a first side, a second side, and a third side, wherein the first, second, and third sides present an interior surface, wherein the first side is spaced apart from the second side by the third side, wherein the interior surface of the first side faces the interior surface of the second side, wherein the third side is positioned perpendicular to and is connected with the first and second sides, and wherein a grate channel is defined by the interior surface of the first, second, and third sides; and
a plurality of cross bars, each cross bar comprising a front side, a rear side, a top side, and a plurality of connections, wherein the front, rear, and top sides present an inner surface, wherein the front side is separated from the rear side by the top side, wherein the inner surface of the front side faces the inner surface of the rear side, wherein the top side is positioned perpendicular to and is connected with the front and rear sides, and wherein a cross channel is defined by the inner surface of the front, rear, and top sides,
wherein at least two of the plurality of grate bars are positioned atop at least two of the plurality of cross bars, wherein the at least two grate bars intersect with the at least two cross bars at multiple intersecting regions, and wherein the plurality of connections couple the plurality of grate bars to the plurality of cross bars at the multiple intersecting regions.

2. The grate of claim 1, wherein the plurality of connections include multiple pairs of grooves which extend through the top side and at least parts of the front and rear sides of each of the at least two cross bars.

3. The grate of claim 2, wherein each of the multiple pairs of grooves comprise a first groove and a second groove, and wherein, at the multiple intersecting regions, the first groove receives a portion of the first side of each of the at least two grate bars and the second groove receives at least a portion of the second side of each of the at least two grate bars.

4. The grate of claim 3, wherein the grate channel includes a first width and a second width that are distances between the interior surface of the first side and the interior surface of the second side along the grate channel, wherein the second width is a distance different from the first width, wherein the grate channel is at the second width at a location in at least one of the multiple intersecting regions, and wherein the grate channel is at the first width at a location between two cross bars coupled with the grate bar.

5. The grate of claim 4, further comprising a sound deadening material,
wherein the sound deadening material is located in the grate channel of at least two grate bars.

6. The grate of claim 5, where the sound deadening material is also located in the cross channel of at least two cross bars.

7. A grate configured to cover an air duct and having a first end, a second end, a front end, and a rear end, the grate comprising:
a plurality of cross bars extending in a lateral direction between the front end and the rear end, wherein each cross bar includes a front side, a rear side, a top side;
a plurality of grate bars extending in a longitudinal direction between the first end and the second end, wherein the grate bars are positioned atop and perpendicular to the plurality of cross bars, wherein each grate bar includes a first side, a second side, and a third side which are joined together and present an interior surface forming a grate channel defined by the interior surface of the first, second, and third sides, and wherein the grate channel includes a width that is a distance between the interior surface of the first and second sides in a transverse direction; and
a plurality of connections including multiple pairs of grooves, wherein each of the multiple pairs of grooves includes a first groove and a second groove, both of which are configured to partially extend through an upper portion of each cross bar in the same direction as the plurality of grate bars extend between the first end and the second end of the grate, wherein the first groove is further configured to receive the first side of each grate bar, and wherein the second groove is further configured to receive the second side of each grate bar;
wherein the plurality of cross bars and the plurality of grate bars overlap at multiple intersecting regions and do not overlap at multiple non-intersecting regions, wherein the multiple pairs of grooves are positioned at the multiple intersecting regions, wherein the first groove of each of the multiple pairs of grooves receives the first side of each grate bar and wherein the second groove receives the second side of each grate bar, wherein the grate channel of each grate bar is a first width at the multiple non-intersecting regions and a second width at the multiple intersecting regions, and wherein the second width is greater than the first width.

8. The grate of claim 7, wherein each grate bar has a similar structure, is positioned parallel to each other grate bar, and is separated from each adjacent grate bar by an equal distance, and wherein each cross bar has a similar structure, is positioned parallel to each other cross bar, and is separated from each adjacent cross bar by an equal distance.

9. A grate configured to cover an air duct positioned within a floor, the grate comprising:
a plurality of grate bars having a first end, a second end, and first and second sides spaced apart by a third side, wherein each of the grate bars has an upside down “U” shaped cross-section with an interior surface that defines a grate channel; and
a plurality of cross bars having a front end, a rear end, and front and rear sides space apart by a top side, wherein each of the cross bars has an upside down “U” shaped cross-section with an interior surface that defines a cross channel;
wherein the plurality of grate bars are position at least slightly above the plurality of cross bars and in an orientation perpendicular thereto,
wherein the plurality of grate bars overlap with the plurality of cross bars at multiple intersecting regions and do not overlap with the plurality of cross bars at multiple non-intersecting regions,
wherein the cross bars have pairs of grooves through the top side and parts of the front and rear sides at the portions of the cross bars located in the intersecting regions,
wherein portions of the first and second sides of the grate bars are received in the pairs of grooves in the intersecting region, whereby the grate bars sit on top of the cross bars, and
wherein the grate channels of the grate bars are a first width at the multiple non-intersecting regions, wherein the grate channels of the grate bars are a second width at the multiple intersecting regions, and wherein the second width is greater than the first width.

10. The grate of claim 9, wherein each of the grate bars are formed from a strip of metal cut from a sheet of metal.

11. The grate of claim 10, wherein the strip of metal is formed into the “U” shaped cross-section by being bent around a form.

12. The grate of claim 10, wherein the sheet of metal is a sheet of prefinished stainless steel.

13. The grate of claim 10, wherein the sheet of metal is one or more materials selected from the following:
a) stainless steel;
b) mild steel;
c) aluminized steel;
d) painted steel;
e) galvanized steel;
f) aluminum;
g) copper;
h) cupronickel; or
i) Muntz metal.

14. The grate of claim 9, wherein each of the cross bars are formed from a strip of metal cut from a sheet of metal.

15. The grate of claim 14, wherein the strip of metal is formed into the “U” shaped cross-section by being bent around a form.

16. The grate of claim 14, wherein the sheet of metal is a sheet of prefinished stainless steel.

17. The grate of claim 14, wherein the sheet of metal is one or more materials selected from the following:
a) stainless steel;
b) mild steel;
c) aluminized steel;
d) painted steel;
e) galvanized steel;
f) aluminum;
g) copper;
h) cupronickel; or
i) Muntz metal.

18. The grate of claim 9, wherein each of the grate bars and the cross bars are formed from a strip of metal cut from a sheet of metal, wherein the strip of metal is formed into the “U” shaped cross-section by being bent around a form, and wherein the sheet of metal is a sheet of prefinished stainless steel.

19. The grate of claim 18, wherein the grate channels of the grate bars have a uniform width along a length of the grate channel after the grate bars are formed by being bent around the form, wherein that uniform width is equal to the first width, wherein the first width is equal to a distance between the pairs of grooves in the cross bars, whereby the first and second sides of the grate bar may be received into the grooves, wherein the first and second sides of the grate bar are moved away from each other in an area received in the grooves after the first and second sides are received in the grooves, and wherein the first and second sides of the grate bar are moved away from each other in the area received in the grooves to a distance equal to the second width, thereby coupling the grate bar with the cross bar.
